(19) United States
(12) Patent Application Publication
(10) Pub. No.: US 2008/0116051 A1
(43) Pub. Date: May 22, 2008

(54) MAIN COLUMN BOTTOMS COKING DETECTION IN A FLUID CATALYTIC CRACKER FOR USE IN ABNORMAL SITUATION PREVENTION

(75) Inventors: John P. Miller, Eden Prairie, MN (US); Ravi Kant, Savage, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/862,864

(22) Filed: Sep. 27, 2007

Related U.S. Application Data
(60) Provisional application No. 60/848,482, filed on Sep. 29, 2006.

(51) Int. Cl. C10B 47/00; G06F 15/00

(52) U.S. Cl. 201/1; 702/179; 702/183

(57) ABSTRACT

A method and system for detecting and/or predicting abnormal solids buildup in a main fractionator bottom of a fluid catalytic cracking system measures one or more process parameters of the fluid catalytic cracking system (such as a differential pressure across a reactor cyclone, a noise after the main fractionator bottom, a heat transfer at the steam generator, and/or a differential pressure across the main fractionator) and determines abnormal solids buildup when the measured process parameter(s) changes significantly from a baseline value. The method and system implements algorithms using computing devices to detect or predict an abnormal condition based on the change in the process parameter.

This application claims the benefit of U.S. Provisional Patent Application Ser. No. 60/848,482, filed Sep. 29, 2006, the entirety of which is hereby incorporated by reference herein.

### FIELD OF THE INVENTION

This patent relates generally to performing diagnostics and maintenance in a process plant and, more particularly, to providing diagnostics capabilities within a process plant in a manner that reduces or prevents abnormal situations within the process plant.

### BACKGROUND

Fluid catalytic cracking is a commonly used process in modem oil refineries to crack high molecular weight oil (hydrocarbons) into lighter components including liquefied petroleum gas, gasoline, and diesel. Generally, the fluid catalytic cracking process uses a catalyst to first break down the high molecular weight oil and then uses at least one cyclone to separate the resulting mixture into byproducts. The byproducts, in the form of reactor effluents, may then be further separated into specific end products using a fractional distillation column, sometimes called a main fractionator or a main column.

One problem that may occur in a fluid catalytic cracking system is buildup of solids in the main fractionator bottom loop, which generally includes several shell and tube heat exchangers, steam boilers, and bottom circulation pumps. The main fractionator bottom loop may be a significant energy recovery loop in the refinery, which is used to recover heat from the slurry in the main fractionator bottom. The heat from the slurry may be used to pre-heat feed input to a fluid catalytic cracking reactor and to generate steam for general refinery usage. High solid content in this energy recovery loop may be caused by a high rate of coke formation and/or a high rate of solids loss from the fluid catalytic cracking unit reactor cyclones.

An increased level of solids content in the main column bottom loop may significantly affect the operation of the bottom circulation loop. For example, increased fouling of the downstream exchangers and steam boilers is caused by the presence of high levels of coke and reactor solids in the oil slurry. This fouling may significantly reduce heat recovery and increase pressure drop and pumping costs. The high level of solids may also cause high wear and tear on the circulation pumps.

Early detection of the rate of solids build up during start up and normal operation may help an operator adjust the fluid catalytic cracking operation so that degradation in performance of the energy recovery loop may be minimized and so that the run length of the exchangers and boilers may be maximized.

### BRIEF DESCRIPTION OF THE DRAWINGS

FIG. 1 illustrates a fluid catalytic cracking system;

FIG. 2 illustrates a computing device that may be used to implement a statistical process monitoring algorithm;

FIG. 3 illustrates a statistical process monitoring (SPM) module;

FIG. 4 illustrates an embodiment of an abnormal operation detection module;

FIG. 5 illustrates a process flow diagram of an example method for detecting or predicting abnormal solids buildup;

FIG. 6 illustrates a system for detecting abnormal solids buildup by monitoring the pressure differential across an element downstream from a main fractionator bottom;

FIG. 7 illustrates the system for detecting abnormal solids buildup by monitoring the heat transfer at a steam generator in an energy recovery loop;

FIG. 8 illustrates multiple detection algorithms integrated together into a single detection module;

FIG. 9 illustrates an example process plant in which an abnormal situation prevention system may be implemented;

FIG. 10 illustrates a portion of a process plant showing an abnormal situation prevention system communicating with various devices; and

FIG. 11 illustrates an embodiment of a system for determining the noise across an element downstream from a main fractionator bottom.

### DETAILED DESCRIPTION

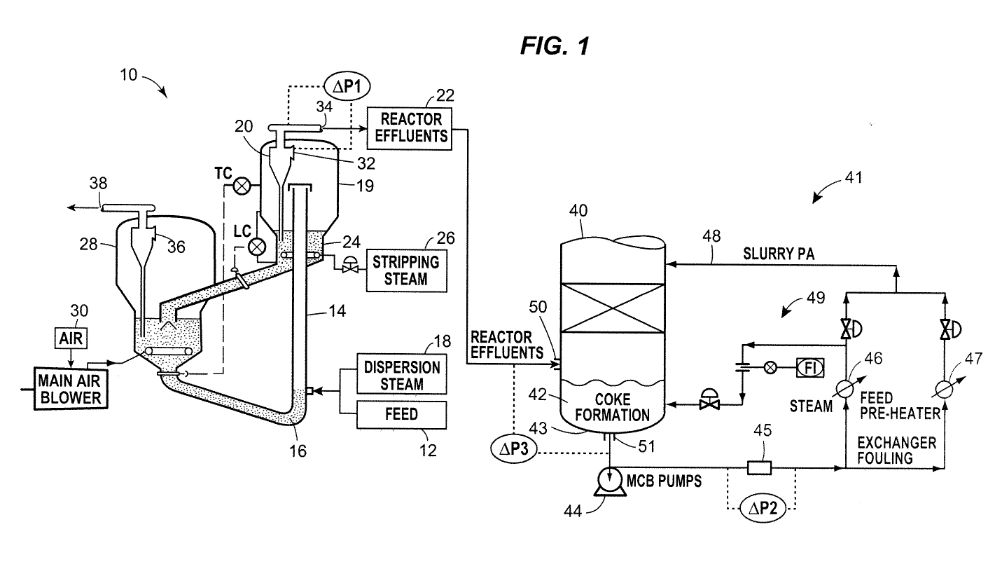

Generally, FIG. 1 illustrates a fluid catalytic cracking apparatus 10 for implementing a fluid catalytic cracking process on high molecular weight oil. A feed 12 comprising the high molecular weight oil may be fed at the bottom of a reactor 14 formed as a vertical or upward sloped pipe, sometimes called a “riser.” A highly active catalyst 16 may be introduced into the riser 14 to contact the feed 12. The feed 12 may be pre-heated and sprayed into the base of the riser 14 via feed nozzles (not shown) where the feed 12 contacts extremely hot fluidized catalyst. Dispersion steam 18 may be used to spray the feed 12 through the feed nozzles. As the hot catalyst contacts the feed 12, the catalyst vaporizes the feed 12 and catalyzes the cracking reactions that break down the high molecular weight oil into lighter components such as liquefied petroleum gas (LPG), gasoline, and diesel. The catalyst-hydrocarbon mixture may then flow upward through the riser 14 and eventually into a disengaging vessel 19. The catalyst-hydrocarbon mixture may be collected in a reactor cyclone 20 and the hydrocarbon portion of the mixture may be separated from catalyst via the reactor cyclone 20. The catalyst may be deposited within the disengaging vessel 19. Cyclone reactor effluents 22 including catalyst-free hydrocarbons may be routed to a main fractionator 40 for further separation into fuel gas, LPG, gasoline, light cycle oils used in diesel and jet fuel, heavy fuel oil, etc.

When the cracking catalyst moves up the riser 14, the cracking catalyst is “spent” by reactions which deposit coke on the catalyst and reduce the activity and selectivity of the catalyst. The used catalyst is disengaged from the cracked hydrocarbon vapors in the disengaging vessel 19 and is sent to a stripper 24 where the used catalyst may be contacted with stripping steam 26 to remove residual hydrocarbons remaining in the catalyst. The spent catalyst may then be directed into a fluidized-bed regenerator 28 where hot air 30 (or in some cases, air plus oxygen) is used to burn off the coke deposits to restore the catalyst to an active state and also to provide the necessary heat for the next reaction cycle. Burning the coke deposits yields flue gas which includes carbon dioxide and carbon monoxide. A regenerator cyclone 36 may be used to further separate flue gas (output at 38) from any remaining solid catalyst of the regenerator 28. The “regenerated” catalyst may be returned to the base of the riser 14 for repeating the cycle.

The cyclone reactor effluents 22 may be received at an input 50 of the main fractionator 40 where a fractional distillation process occurs to separate the various molecular weight byproducts from the effluent hydrocarbon mixture. While not shown in FIG. 1, the main fractionator 40 may include a plurality of drawers or trays from which varying molecular weight byproducts are extracted from the main fractionator. As discussed above, the hydrocarbons may be further separated into fuel gas, LPG, gasoline, light cycle oils used in diesel and jet fuel, heavy fuel oil, etc. FIG. 1 specifically highlights the bottom of the main fractionator 40 which is coupled to an energy recovery loop 41.

A heavy solids mixture 42, also called an oil slurry, may be deposited at the bottom 43 of the main fractionator 40 during the distillation process. The oil slurry 42 may include highly heated coke and reactor solids matter. Heat energy from the hot solids mixture 42 may be recovered through the energy recovery loop 41 to produce steam, which may include the dispersion steam 18, and to pre-heat the feed 12. A pump 44 coupled to the fractionator bottom 43, sometimes called a main column bottom, may draw the heated solids mixture through an outlet 51 and circulate the mixture through the energy recovery loop 41. An element 45 downstream from the pump 44 may introduce a partial constriction on the flow of the solids mixture 42. In one embodiment, the downstream element 45 may be a flow indicator. The flow indicator 45 may include an orifice plate that partially constricts the flow of the solids mixture 42 through the energy recovery loop 41. The flow indicator 45 may operate by measuring a differential pressure across the orifice plate and calculating a flow rate based, in part, on the differential pressure across the orifice plate.

The oil slurry or solids mixture 42 may be pumped through a steam generator 46 and a feed pre-heater 47. The steam generator 46 may use the heat from the oil slurry 42 to produce steam which may then be used, for example, to propel feed into the riser 14. The feed pre-heater 47 may be used to pre-heat the feed 12 before the feed is injected into the riser 14. After passing through the steam generator 46 and the feed pre-heater 47, the partially cooled solids mixture 42 may then be returned, in part, to the fractionator via slurry pump around path 48. In one embodiment, a path 49 may be used to control the temperature at the main fractionator bottom 43 by injecting cooled portions of the mixture into the main fractionator bottom 43.

A problem that may occur in the operation of the fluid catalytic cracking system 10 is an abnormal buildup of solids in the main fractionator bottom 43. Abnormally high levels of solids in the fractionator bottom 43 may negatively impact the energy recovery loop 41. For example, abnormally high solids may cause the slurry 42 to be too viscous and abrasive for the pumps and pipelines to handle, which may cause severe clogging and damage to the equipment coupled to the energy recovery loop. In one embodiment, abnormal solids buildup in the main fractionator bottom 43 may be detected or predicted by monitoring or measuring one or more process parameters in the fluid catalytic cracking system 10. The process parameters may include: 1) a differential pressure across a reactor cyclone; 2) noise after the main fractionator bottom; 3) heat transfer at the steam generator; and 4) a differential pressure across the main fractionator.

### Solids Loss from Reactor

Abnormally high levels of solids being introduced from the reactor 19 into the main fractionator 40 may contribute to high solids buildup in the main column bottom 43. This increased level of reactor solids may be detected or predicted by monitoring a differential pressure ΔP1 across the reactor cyclone 20. In one embodiment, the differential pressure may be taken across a cyclone input 32 and an effluent output 34 of the reactor cyclone 20, where the effluent output 34 provides the hydrocarbon mixture to the main fractionator 40. If the abnormal solids loss from the reactor is resolved quickly, problems that may arise from solids buildup may be prevented from propagating through to the fractionator energy recovery loop.

### Noise after MCB Pumps

A second method and measurement that may be used to detect solids build-up is a differential pressure ΔP2 across the element 45 (FIG. 1) downstream from the main column bottom 43. In one embodiment, the element 45 may be a flow indicator having an orifice plate downstream from the main column bottom pump 44. In this embodiment, a differential pressure ΔP2 may be monitored and measured. When there exists increased solids in the main column bottom 43, a greater concentration of oil slurry may exist. The high oil slurry may increase the noise in the ΔP2 measurement. The noise may be a standard deviation or variance of differential pressure ΔP2, which, as is known, may be proportional to a flow rate of the slurry through the energy recovery loop 41. Thus, in effect, solids buildup in the main fractionator bottom 43 may be detected by detecting abnormal variations in the standard deviation of the rate of flow of the oil slurry from the main fractionator bottom.

### Heat Transfer at Steam Generator

A third method that may be used to detect solids build-up is to monitor the heat transfer (Q) at the steam generator 46 (FIG. 1), which may be calculated as:

i Q=w·cₚ·ΔT,

where w is the mass flow rate, cₚ is the specific heat, and ΔT is the differential temperature. If a constant specific heat and density is assumed, then the specific heat cₚ may be ignored, and the mass flow rate may be replaced by a volumetric flow rate. Sensors may be disposed around the steam generator 46 to measure the heat between an input of the steam generator 46 and an output of the steam generator 46 to determine the differential temperature ΔT. Sensors may also be used to monitor or measure the flow rate of the steam generator. A decrease in the value of Q may indicate incipient coking due to the high concentration of solids in the pipelines (e.g., the pipelines of the energy recover loop 41 of FIG. 1) , and may be used for predictive detection of the high solids buildup in the main column bottom 43.

### Differential Pressure Across Column

Another method for detection of solids build-up may be made by monitoring a differential pressure between the column input 50 and the column bottom output 51, which is represented as ΔP3 in FIG. 1. An increase in this differential pressure ΔP3 may indicate increased coking.

### Detecting Abnormal Solids Buildup

An abnormal operation detection system as described herein may be implemented to predict or detect abnormal solids buildup in the main fractionator bottom 43 so that preventative measures may be taken to prevent or reduce the solids in the main column bottom 43. The abnormal operation detection system may be implemented in an existing process control system or installed as an independently functioning computing unit.

Generally, the abnormal operation detection system may be implemented as hardware or software running on one or more computing devices. The following describes various types of algorithms that may be implemented by the abnormal operation detection system to detect or predict abnormal solids buildup in a main column bottom of a fluid catalytic cracking system.

### Statistical Process Monitoring

One algorithm that may be used for determining abnormal solids buildup in the main column bottom uses one more statistical process monitoring (SPM) algorithms. SPM algorithms may be used to monitor one or more of the process parameters described above and flag an operator when the one or more process parameters is detected to have moved from a “statistical” norm. The SPM algorithm may generally calculate the mean and standard deviation of a process parameter, such as a pressure differential, over non-overlapping sampling windows.

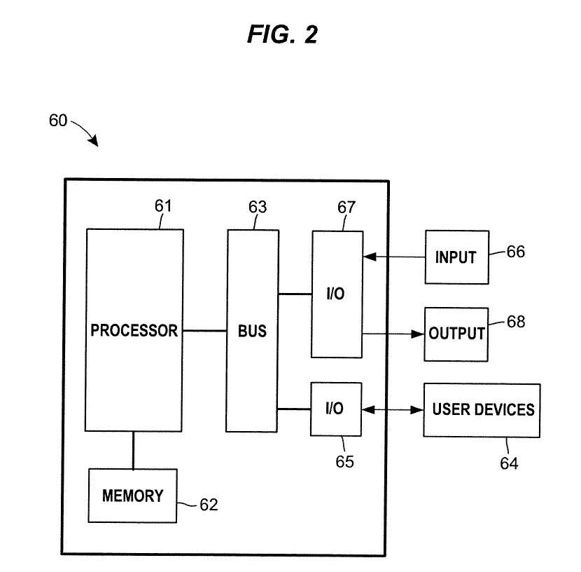

FIG. 2 illustrates a computing device that may be used to implement an SPM algorithm, implemented in one embodiment as an SPM function block. Components of computing device 60 may include, but are not limited to, a processing unit 61 (such as a microprocessor) a system memory 62, and a system bus 63 that couples various system components to the processing unit 61. The memory 62 may use any available media that is accessible by the processing unit 61 and may include both volatile and nonvolatile media, removable and non-removable media. A user may enter commands and information into the computing device 60 through user input devices 64, such as a keyboard and a pointing device. These and other input devices and output devices (such as a user display) may be connected to the processing unit 61 through a user input interface 65 that may be coupled to the system bus 63. A monitor or other type of display device may also be connected to the processor 61 via the user interface 65. Other interface and bus structures may also be used. In particular, inputs from other devices 66 (e.g., sensors), may be received at the computing device 60 via an input/output (I/O) interface 67 and outputs 68 from the computing device 60 may be provided by the input/output (I/O) interface 67 to other devices. Thus, the interfaces 65 and 67 connect various devices to the processor 61 via the system bus 63.

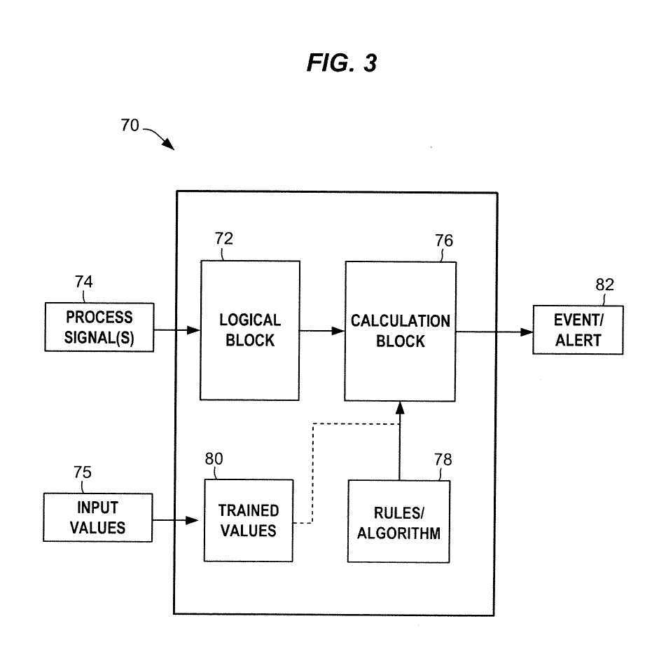

FIG. 3 illustrates a statistical process monitoring (SPM) module 70 that may be implemented on, for example, the computing device 60 of FIG. 2. A logical block 72 may receive a set of process signals 74 and may calculate statistical signatures or statistical parameters for the set of process signals 74. These statistical parameters may be calculated based on a sliding window of process variable data or based on non-overlapping windows of process variable data. The calculated statistical parameters or statistical signatures may include mean, standard deviation, variance (S²), root-mean-square (RMS), rate of change (ROC) and range (ΔR) of the process signal, for example. In particular, these statistical parameters may be given by the following equations:

$$mean = x = \frac{1}{N} {\sum }_{i = 1}^{N} {X}_{i}$$

$$S = STANDARD\_DEVIATION = σ$$

$$\begin{matrix}VARIANCE = {( STANDARD\_DEVIATION )}^{2} \\ = {S}^{2} = \frac{1}{n - 1} {\sum }_{i = 1}^{N} {( {x}_{i} - \overline{x} )}^{2}\end{matrix}$$

$$RMS = \sqrt{\frac{1}{N} {\sum }_{i = 1}^{N} {x}_{i}^{2}}$$

$$R O C = {r}_{i} = \frac{{x}_{i} - {x}_{i - 1}}{T}$$

$$Δ R = {X}_{MAX} - {X}_{MIN}$$

In the equations above, N is the total number of data points in the sample period, xᵢ and xᵢ₋₁ are two consecutive values of the process signal, and T is the time interval between the two values. Further, X_{MAX} and X_{MIN} are the respective maximum and minimum of the process signal over a sampling or training time period. These statistical parameters may be calculated alone or in any combination. Additionally, it will be understood that the invention includes any statistical parameter other than those explicitly set forth which may be implemented to analyze a process signal. The calculated statistical parameter(s) may be received by a calculation block 76 which operates in accordance with rules contained in a rules block 78. The calculation block 76 may process the statistical parameters from logical block 72 and provide an output based on a set of rules defined in a rules block 78. The rules block 78 may be implemented, for example, in a portion of the memory 62 of computing device 60 and may define an algorithm for detecting or calculating an abnormal situation, as further discussed below.

The calculation block 76 may also receive values from a trained values block 80. Trained values contained in the trained values block 80 may represent a set of nominal (i.e., typical) statistical parameter values for the process signal which may correspond to the set of statistical parameters (standard deviation, mean, sample variance, root-mean-square (RMS), range and rate of change, etc.) calculated by the logical block 72 in a set of training data, which typically represents data collected by the system during normal operation of the process. In one embodiment, the trained values may be provided externally to the SPM module 70 via an input 75. The externally provided values may be provided by an operator or manufacturer and stored, for example, in the memory 62 of computing device 60. In one embodiment, the trained values may represent a set of threshold values corresponding to one or more elements of the set of statistical parameters.

In another embodiment, the trained values may be calculated and periodically updated, for example, by the computing device 60. For example, in one embodiment, the trained values may be generated by the statistical parameter logical block 72 which generates, or learns, the nominal or normal statistical parameters during a first period of operation, typically a period during normal operation of the process. These nominal statistical parameters may then be stored as trained values in the training block 80 for future use (as described further below). This operation allows dynamic adjustment of trained values 80 for a specific loop and operating condition. In this situation, statistical parameters (which may be used for the trained values) may be monitored for a user selectable period of time based upon the process dynamic response time. In one embodiment, a computing device such as the computing device 60 may generate or receive the trained values or be used to transmit the trained values to another process device.

In one embodiment, the SPM module 70 illustrated in FIG. 3 may be used to implement an algorithm for detecting abnormal solids buildup in the main column bottom by receiving an input such as the pressure differential across a reactor, the noise across the flow indicator 45, a heat transfer at a steam generator, and/or a pressure differential across the main fractionator, and may determine abnormal conditions based on the input. If desired, the SPM module 70 may receive signals indicative of the measured variables (such as pressure signals, flow signals, etc.) and calculate the pressure differential across a reactor, the noise across the flow indicator 45, a heat transfer at a steam generator, and/or a pressure differential across the main fractionator, and may determine abnormal conditions based on the input therefrom. In this embodiment, the SPM block 70 may act as an abnormal operation detection (AOD) module. In this configuration, the rules block 78 may contain rules for calculating an abnormal condition based on received or calculated process parameter values. The calculation block 76 may be programmed to output statistical signature values as well as an event indicator or status indicator (e.g., an alert) 82 when an abnormal condition is detected. Here, the observed process parameter value(s) may be sampled at regular intervals and input into the SPM module 70 of FIG. 3 as the process signal 74. During a learning phase, the logical block 72 may determine a baseline mean (p) and a baseline standard deviation (σ) of the process parameter. These statistical parameters may be considered a representation of the process in a “normal” condition. The baseline mean and baseline standard deviation may then be stored in the memory 62 as trained values (i.e., using block 80). Alternatively, the threshold values may be supplied externally by another device or by a user via the input 75. During a monitoring phase, the SPM block 70, implementing the algorithm, may obtain or calculate current values of the pressure difference, or other process parameter, and calculate the mean ( x̅) and standard deviation (s) over non-overlapping sampling windows with the same length as the sampling window used during the learning period.

Using the SPM algorithm implemented by the SPM block 70, increased solids buildup may be detected at the calculation block 76 if the actual or current mean of one of the process parameters differs from the baseline mean of the process parameter by more than some threshold. In this case, an indication or an alarm 82 may be output indicating the abnormal condition. For example, abnormal solids buildup may be detected if the current mean is more than a certain percent above or below the baseline mean:

$$\overline{x} < ( 1 - \frac{α}{100} ) \cdot μ$$

where α is some user-defined percent (e.g., 5%). This equation may be represented as one or more rules in the rules block 78. In one embodiment, the SPM module 70 may include an input for a detection threshold (e.g., one determined by a user). If desired, the detection threshold may be stored as a trained value.

One drawback to the above described approach may be that a user with knowledge of the process may have to determine an appropriate value for α. This requirement may be tedious and time consuming, especially when there are many different process variables for which a threshold needs to be set.

In another embodiment, the threshold may be set based on a variance observed during the learning phase. For example, abnormal solids buildup may be detected if x̅<μ−3σ or x̅>μ+3σ. In this case, the observed variance may be stored in the memory 62 via the trained value block 80. Thus, in this embodiment, the detection threshold is determined automatically, and the amount of manual configuration may be reduced. It should be noted that any other multiplier for the standard deviation besides three (3) may be used, depending on the observed or detected variance or the desired sensitivity of the abnormal situation detection. Also, while the variance multiplier may be automatically calculated by the SPM module 70 this multiplier may be a user-configurable parameter input as a trained variable (e.g., via the input 75).

### Regression and Residual Monitoring

The use of an SPM algorithm may be appropriate for detecting abnormal solids buildup in the main fractionator bottom if the monitored process parameter or condition changes only when solids buildup occurs. However, if the monitored process parameter or condition changes due to other factors (e.g., due to load changes or other expected changes in process conditions), then the SPM algorithm may trigger false alarms. In one embodiment, more than a single set of SPM derived characteristics (e.g., mean, standard deviation, etc.) may be generated depending on the operating condition or operating state of the fluid catalytic cracking unit. For example, if there are two different loads in which the fluid catalytic cracking system operates, then the calculation block 76 may be programmed to implement one set of rules (e.g., stored in the rules block 78) for a first load condition and to implement a second set of rules (e.g., stored in rules block 78) for a second load condition. In an alternative embodiment, two SPM blocks may be used, where activation of one or the other SPM block may be based on a detected load condition or other expected process condition.

While multiple SPM blocks may be used for simple condition changes (e.g., when only two load possibilities exist), multiple SPM blocks may be inefficient when many expected operating conditions exist. In this case, some form of regression analysis (e.g., developing a regression model and then monitoring the residuals) may be used to detect abnormal solids buildup in the main column bottom.

In general, during a learning phase of a regression analysis, data is collected on the selected process parameter(s) indicative of solids buildup (y), and from other process variable(s) which may have some effect on the selected process parameter (x₁, x₂, . . . xₘ). A model may be developed to predict the value of solids buildup y as a function of the process variables x's. This function may be expressed as:

ŷ=f(x₁, x₂, . . . xₘ)

This model may be anything from a simple multiple linear regression model, e.g.,

f(x₁, x₂, . . . xₘ)=α_{0α}₁x₁+α₂x₂+. . . +αₘxₘ,

with coefficients calculated according to any known method such as ordinary least squares (OLS), principal component regression (PCR), partial least squares (PLS), variable subset selection (VSS), support vector machine (SVM), etc.), to something more complicated, such as a neural network model. As discussed further below, once the model is developed during the monitoring phase, the model may be used to calculate the residual (difference between actual and predicted process parameter values). If the residual exceeds some threshold, then an abnormal situation may be detected.

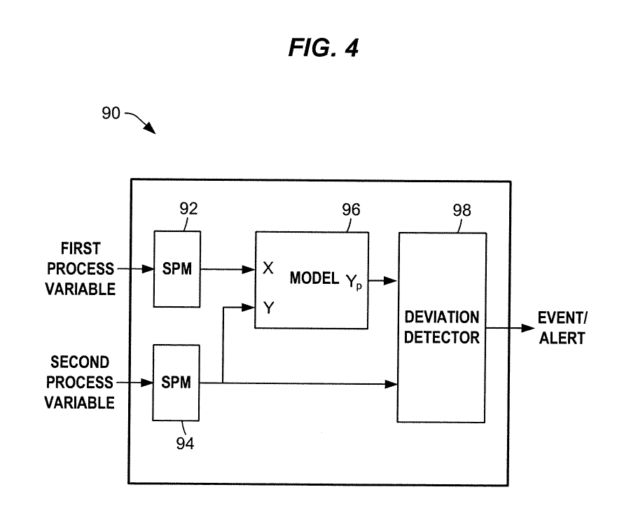

FIG. 4 illustrates an embodiment of an abnormal operation detection (AOD) module 90 that may be used to implement a regression and residual monitoring algorithm. The AOD module 90 may include a first SPM block 92 and a second SPM block 94 coupled to a model implementation block 96. The first SPM block 92 may operate similarly to the SPM module 70 illustrated in FIG. 3. As such, the first SPM block 92 receives a first process variable and generates first statistical data from the first process variable. As discussed above, this operation may include generating statistical signature data such as mean data, median data, standard deviation data, rate of change data, range data, etc., calculated from the first process variable. Such data may be calculated based on a sliding window of first process variable data or based on non-overlapping windows of first process variable data. As one example, the first SPM block 92 may generate mean data using a most recent first process variable sample and 49 previous samples of the first process variable. In this example, a mean variable value may be generated for each new first process variable sample received by the first SPM block 92. As another example, the first SPM block 92 may generate mean data using non-overlapping time periods. In this example, a window of five minutes (or some other suitable time period) may be used, and a mean variable value would thus be generated once for every five minute period. In a similar manner, the second SPM block 94 receives a second process variable and generates second statistical data from the second process variable in a manner similar to the SPM block 92. In one embodiment, only one of the SPM blocks 92 or 94 may be used (e.g., only the block 92). In another embodiment no SPM block 92 or 94 may be used.

The model implementation module or block 96 may receive, during a first period, a dependent variable Y representing a selected, monitored process parameter indicative of solids buildup (e.g., pressure differential across reactor cyclone, noise across an element downstream from main column bottom pump, heat transfer at a steam generator, or pressure differential across a main fractionator) and an independent variable X representing a set of process variables that may have some effect on the selected process parameter (e.g., load). As will be described in more detail below, the model implementation block 96 may generate a regression model using a plurality of data sets (X, Y) to model Y (e.g., the pressure difference ΔP) as a function of X (e.g., one or more independent variables affecting ΔP).

The model implementation block 96 may include one or more regression models, each of which may utilize a function to model the dependent variable Y as a function of the independent variable X over any range of X, over a specified range of X, and/or over multiple ranges of X. For example, it is possible that a single X-variable might be used to predict the y-variable under all normal operating conditions. In this case, any known univariate regression method may be used. In another embodiment, different models may be developed for different ranges. For example, in an extensible regression approach, a regression model may be developed for multiple ranges of the independent variable X. This general approach is further described in U.S. application Ser. No. 11/492,467, which is hereby incorporated by reference herein.

In one embodiment, the regression model may include or use a linear regression model. Generally, a linear regression model uses some linear combination of functions f(X), g(X), h(X), etc. or for modeling an industrial process, a typically adequate linear regression model may include a first order function of X (e.g., Y=m*X+b) or a second order function of X (e.g., Y=a*X²+b*X+c). Of course, other types of functions may be utilized as well, such as higher order polynomials, sinusoidal functions, logarithmic functions, exponential functions, power functions, etc.

After the model has been trained, the model implementation block 96 may be used to generate a predicted value (Y_{P}) of a dependent variable Y during a second period of operation based on a given independent variable X input measured during the second period. In the situation where the selected monitored process parameter is a differential pressure ΔP1 across a reactor cyclone, Y_{P} may represent the predicted differential pressure ΔP1 whereas Y may represent an actual or current measure of the differential pressure ΔP1. The predicted ΔP1 (or Y_{P}) of the model implementation block 96 may be provided to a deviation detector 98. The deviation detector 98 may receive the predicted ΔP1 (or Y_{P}) of the regression model of the block 96 as well as the dependent variable input Y (representing an actual or current measure of ΔP1). Generally speaking, the deviation detector 98 may compare the actual pressure differential ΔP1 to the predicted pressure differential ΔP1 to determine if the actual pressure differential ΔP1 is significantly deviating from the predicted pressure differential ΔP1. If the actual pressure differential ΔP1 is significantly deviating from the predicted pressure differential ΔP1, this may indicate a situation where an abnormal solids buildup has occurred, is occurring, or may occur in the near future. As a result, the deviation detector 98 may generate an indicator of the deviation. In some implementations, the indicator may be an alert or alarm indicating abnormal solids buildup in the main fractionator.

The difference between an actual process parameter value Y and a predicted pressure differential Y_{P} may be called a residual. The deviation detector 98 may be configured to generate an alarm only after a certain threshold residual value is reached or exceeded. Any of various known methods may be used to establish the threshold for detecting the abnormal solids buildup for a selected/monitored process parameter. Similar to the SPM model described above, the threshold may be, for example, a certain percentage of the predicted Y-value, or it may be based on the variance of the residuals calculated using the training data. Also, any form of alarming logic (e.g., two or more consecutive observations exceeding a threshold) may be used prior to generating an alarm seen by plant personnel.

One of ordinary skill in the art will recognize that the AOD module 90 may be modified in various ways. For example, the process variable data may be filtered, trimmed, etc., prior to being received by the SPM blocks 92 and 94. In another embodiment the SPM blocks 92 and 94 may not be used. Additionally, although the model in block 96 is illustrated as having a single independent variable input X, a single dependent variable input Y, and a single predicted value Y_{P}, the model in block 96 may include a regression model that models multiple variables Y (e.g., one or more of the process parameters indicative of solids buildup) as a function of multiple variables X. The model in block 96 may comprise a multiple linear regression (MLR) model, a principal component regression (PCR) model, a partial least squares (PLS) model, a ridge regression (RR) model, a variable subset selection (VSS) model, a support vector machine (SVM) model, etc. For example, two differential pressures such as the differential pressure across the reactor cyclone 20 and across the main fractionator 40 may be modeled. In this example, the independent variable set X may represent process characteristics that effect both the differential pressure ΔP1 over the reactor cyclone 20 and differential pressure ΔP3 over the main fractionator.

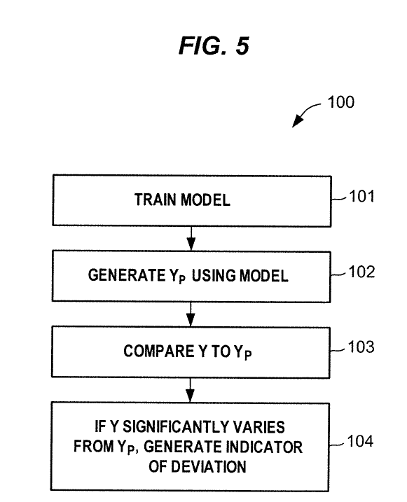

FIG. 5 illustrates a process flow diagram of an example method for detecting or predicting abnormal solids buildup in the main column bottom in a fluid catalytic cracking system. The method 100 may be implemented using the example AOD module 90 of FIG. 4. At a block 101, a model implementation block, such as the block 96, may be trained. For example, the model may be trained using independent variable X and dependent variable Y data sets to configure this model to predict Y as a function of X. The model may include, for example, multiple regression models that each model Y as a function of X for a different range of X.

Then, at a block 102, the trained model generates predicted values (Y_{P}) of the dependent variable Y using values of the independent variable X that it receives. Next, at a block 103, the actual values of Y are compared to the corresponding predicted values Y_{P} to determine if Y is significantly deviating from Y_{P}. For example, the deviation detector 98 may receive the output Y_{P} of the model block 96 and may compare the output Y_{P} to the dependent variable Y. If Y significantly deviates from Y_{P}, a block 104 may generate an indicator of the deviation. In the AOD module 90, for example, the deviation detector 98 may generate the indicator. The indicator may be an alert or an alarm, for example, or any other type of signal, flag, message, etc., indicating that a significant deviation has been detected.

As will be discussed in more detail below, the block 101 may be repeated after the model has been initially trained and after it has generated predicted values Y_{P} of the dependent variable Y. For example, the model may be retrained if a set point in the process has been changed, or at other times during operation of the process.

### Detection of Main Column Bottom Solids Buildup

Theoretically, any possible combination of detection methods and learning algorithms as described above may be used to detect (or prevent) main column bottom coking. Some possible combinations are described below.

### Solids Loss from Reactor

A statistical process monitoring (SPM) algorithm may be used for detecting abnormal solids buildup due to solids loss from the reactor if the monitored differential pressure ΔP1 across the reactor cyclone 20 (FIG. 1) is only affected by abnormal solids loss. Otherwise, some regression and residual monitoring algorithm may be implemented if there are other process variables that affect the monitored variable.

Specifically, with reference to FIGS. 1 and 3, the differential pressure across the reactor cyclone 20 may be measured by a set of sensors and input to the SPM module 70 as the process signal 74. The SPM module 70 may calculate a mean value of the differential pressure over an initial learning period as part of its statistical signature calculations. The calculation block 76 may then determine an abnormal solids buildup due to solids loss from the reactor cyclone 20 if a current monitored value of the differential pressure ΔP1 deviates from the mean of the differential pressure ΔP1 by more than a threshold. The function of comparing the current differential pressure ΔP1 to the mean of the differential pressure ΔP1 may be separate from the SPM module in another embodiment, where the calculation block 76 merely outputs, in part, the mean value of the differential pressure ΔP1. A decrease in the differential pressure across the reactor cyclone may indicate increased solids loss and increased solids buildup in the main columns bottom.

Referring to FIG. 4, a regression model may be used to detect the abnormal solids buildup using the differential pressure ΔP1 across the reactor cyclone 20 as the selected process parameter. During a first period, the AOD module 90 may use the block 96 to develop a regression model based on a monitored or measured value of the differential pressure ΔP1 and a monitored value of a set of process parameters affecting the differential pressure ΔP1. The generated model may then be implemented by the module 90 during a second period to predict a value of the differential pressure ΔP1 based on the second set of process parameters monitored during the second period. The detection module 98 may determine an abnormal solids buildup event if the predicted and actual values of the differential pressure ΔP1 differ by more than a threshold.

### Noise After Main Column Bottom Pump

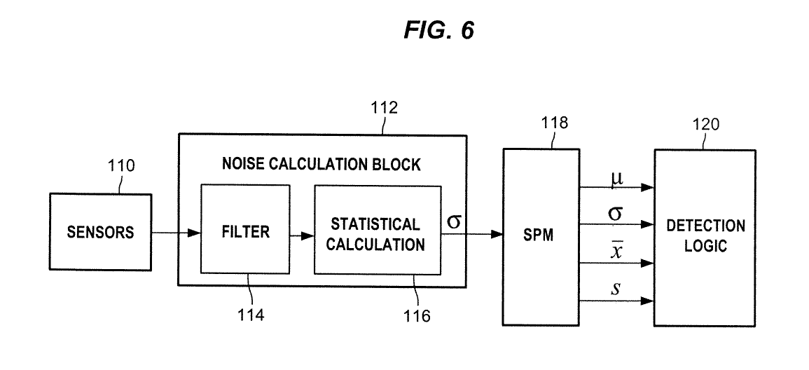

Solids buildup in the main column bottom may manifest as an increase in the noise of the differential pressure ΔP2 across the element 45 after the main column bottom pump 44. The noise across the element 45 may be measured as a standard deviation or variance of the differential pressure ΔP2. In one embodiment, the noise may be more efficiently observed by applying a filter to the monitored or measured values of the differential pressure ΔP2 across the element 45. With reference to FIG. 6, a set of sensors 110 may provide data on the measured differential pressure across the element 45 to a filter 114. Generally, a high pass filter may be appropriate. If the specific noise characteristics of the oil slurry flow are known (e.g., the specific frequencies at which an increase in the slurry is easily observable), then a custom filter may be designed to pass only those frequencies of interest. However, if nothing specific is known, then a first-order high-pass (differencing) filter may be used, such as:

$${y}_{k} = \frac{{x}_{k} - {x}_{k - 1}}{2} ,$$

where xₖ is the input (raw sampled) data, and yₖ is the filtered data.

After the values of the differential pressure across the element 45 are filtered, a first SPM block 116, such as the SPM 70 of FIG. 3, may be used to calculate a standard deviation and/or a variance of the filtered differential pressure values. The output of the first SPM block 116 may then be considered to be a measure of the noise of the slurry flow across the element. In one embodiment, the filter 114 and SPM block 116 may be implemented as a noise calculation module 112.

In one embodiment, the noise of the differential pressure across the element may be monitored or measured over an initial learning period to determine a mean of the noise, or a mean of the standard deviation or variance of the differential pressure across the element. If the noise deviates from the mean during a second period (e.g., a period of normal operation) by more than a threshold, then an abnormal solids buildup event may be detected. Again, the threshold may be determined in any of a number of ways as described above. The mean and standard deviation of the noise calculated by the first SPM block 116 may be calculated by a second SPM block 118. A detection module 120 may store the mean noise value and the standard deviation or variance of the noise value from the learning period, continue to monitor the noise value during a second period, and generate an indication of an abnormal solids buildup when the deviation between the values from the first and second period exceed a set threshold.

In one embodiment, a regression model may be used to detect abnormal solids buildup via monitoring the differential pressure across the element 45. Referring to FIG. 4, during a first period, the AOD module 90 may use block 96 to develop a regression model based on the noise calculated from the noise calculation block 112 and a monitored value of a set of process parameters affecting the noise. The generated model may then be implemented by the module 90 during a second period to predict a value of the noise based on the second set of process parameters monitored during the second period. The detection module 98 may determine an abnormal solids buildup event if the predicted and actual values of the differential pressure ΔP2 differ by more than a threshold.

In one embodiment, the regression model of block 96 of AOD module 90 may be generated based on the statistical signatures (e.g., mean, standard deviation, variance, etc.) determined by the second SPM module 118 (FIG. 6) and process parameters affecting the statistical signature values other than solids buildup.

### Heat Transfer At Steam Generator

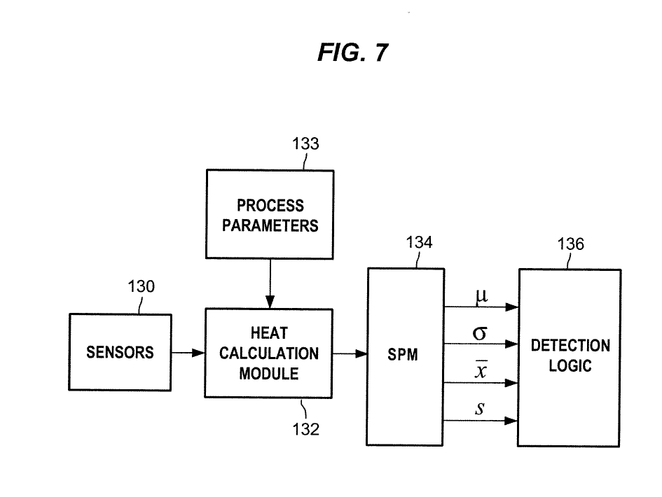

For monitoring the heat transfer at the steam generator, an SPM-based algorithm or a regression-residual-based algorithm may be used. As illustrated in FIG. 7, a set of sensors 130 may provide sensor data to a preliminary heat calculation module or processing module 132 that may be used to calculate the heat transfer according to the equation described above. For example, the heat calculation module 132 may receive from the set of sensors 130 a differential temperature AT and/or a mass flow rate (or volumetric flow rate) and may calculate a heat transfer based on the received inputs. The heat calculation module 132 may store a set of values for the specific heat values and be programmed to use the correct value to determine the heat transfer. For example, the processing module may receive additional inputs 133 (e.g., other process parameters) to determine the appropriate specific heat constant to be used. The processing module 132 may then output a value of the heat transfer to an SPM module 134, where the SPM module 134 determines a statistical signature for the heat transfer similar to the methods described above. A detection unit 136 may be used to store the statistical signature of the heat transfer over a first period and to generate an indication of an abnormal solids buildup should a currently monitored heat transfer value decrease from an initial mean heat transfer by more than a threshold.

Alternatively, a regression model may be used to detect abnormal solids buildup via monitoring the heat transfer at the steam generator. Referring to FIG. 4, during a first period, the AOD module 90 may use the block 96 to develop a regression model based on the heat transfer calculated from the calculation block 132 (FIG. 6) and a monitored value of a set of process parameters affecting the noise. The generated model may then be implemented by the block 90 during a second period to predict a value of the noise based on the second set of process parameters monitored during the second period. The detection module 98 may determine an abnormal solids buildup event if the predicted and actual values of the heat transfer differ by more than a threshold.

It should be noted that a regression-based algorithm may be suitable when heat transfer is the selected monitored process parameter because heat transfer may often change as a result of other process changes.

### Differential Pressure Across Column

SPM and regression based approaches may be used when the differential pressure ΔP3 across the main fractionator 40 is used as the monitored value. Specifically, with reference to FIGS. 1 and 3, the differential pressure ΔP3 across the fractionator 40 may be measured by a set of sensors and input to the SPM module 70 as the process signal 74. The SPM module 70 may calculate a mean value of the differential pressure ΔP3 over an initial learning period as part of its statistical signature calculations. The calculation block 76 may then determine an abnormal solids buildup due to coke buildup if a current monitored value of the differential pressure ΔP3 deviates from the mean of the differential pressure ΔP3 by more than a threshold. The function of comparing the current differential pressure ΔP3 to the mean of the differential pressure ΔP3 may be separate from the SPM module in one embodiment, where the calculation block merely outputs, in part, the mean value of the differential pressure ΔP3. An increase in the differential pressure across the reactor cyclone may indicate increased coke formation and increased solids buildup in the main columns bottom.

When using a regression model, the differential pressure ΔP3 across the main fractionator may be measured over a first period along with a set of process parameters that have an effect on the differential pressure ΔP3. For example, during a first period, the AOD module 90 of FIG. 4 may use the block 96 to develop a regression model based on a monitored or measured value of the differential pressure ΔP3 and a monitored value of a set of process parameters affecting the differential pressure ΔP3. The generated model may then be implemented by the module 90 during a second period to predict a value of the differential pressure ΔP3 based on the second set of process parameters monitored during the second period. The detection module 98 may determine an abnormal solids buildup event if the predicted and actual values of the differential pressure ΔP3 differ by more than a threshold. The detection detector 98 may provide an indication or alarm when an abnormal solids buildup event occurs.

### Integrating Detection Logic

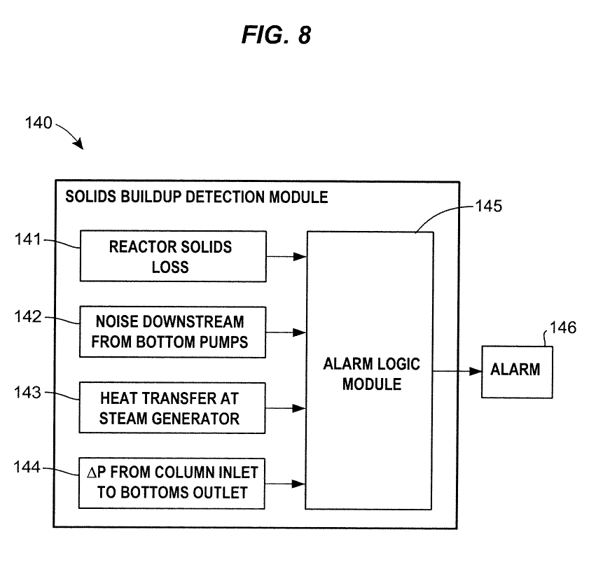

Four different methods for detecting (and hopefully preventing) coke formation and solids buildup in the main column bottom 40 are described above. While any one or more of these detection methods may be used to determine abnormal solids buildup, a single AOD module may be used to integrate the outputs of each of the measurements into a single meaningful indication. FIG. 8 illustrates a manner in which the multiple detection algorithms described above may be integrated together into a single detection module 140 to detect solids buildup in the main column bottom 40 of a fluid catalytic cracking system 10.

Generally, the detection module 140 may include a block for 141 for determining an abnormal change in reactor solids loss, a block 142 for determining an abnormal change in noise downstream from the main column bottom pumps, a block 143 for determining a heat transfer parameter at a steam generator, and a block 144 for determining a differential pressure across a main fractionator inlet and main fractionator bottom outlet. The blocks 141-144 may operate as described above to provide an indication of abnormal change with respect to their corresponding monitored process parameter. Each of the individual detection algorithms 141-144 may or may not be included in the detection module 140, depending on the particular plant.

An alarm logic module 145 may receive the indications from the blocks 141-144 and process the indications according to any alarm logic that is appropriate for a particular plant. In one embodiment, an alarm 146 may be generated by alarm logic module 145 based on a combination of indications from blocks 141-144. For example, in one case, it may be desirable to trigger an alarm 146 if any of the four indicators 141-144 shows an abnormal condition. In another case, it may be desirable that at least two of these indicators shows a solids buildup, prior to triggering an alarm 146.

In another embodiment, the indications provided by blocks 141-144 may be weighted by importance. For example, if it is known that noise buildup across an element downstream from the main column bottom is a more reliable indicator of solids buildup than solids loss from a reactor cyclone, then the indication from block 142 may be weighted greater than the indication from block 141 in determining when to generate alarm 146. In an alternative embodiment, the weights may change depending on a time or a sequence of indications.

In another embodiment, the alarm logic module may be programmed to generate an alarm 146 when a sequential combination of indications is received from the block 141-144. For example, it is known that if there is increased reactor solids loss, and this increase is uncorrected, after some time delay there may also be an increase in the measurement noise downstream from the main column bottom pumps. The alarm logic module 140 may generate an alarm 146 when block 141 provides an abnormal indication followed by block 142. Alarm logic module 140 may also provide different types of alarms 146 based on the correlation between reactor solids loss and noise increases across the element to give both a more meaningful alert and to provide more detailed guided help.

### A Process Control System For Use With the AOD Modules

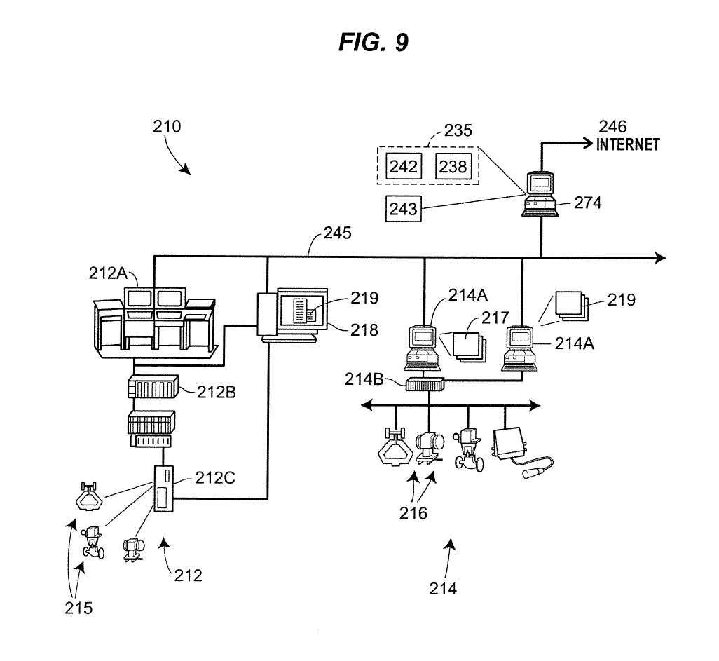

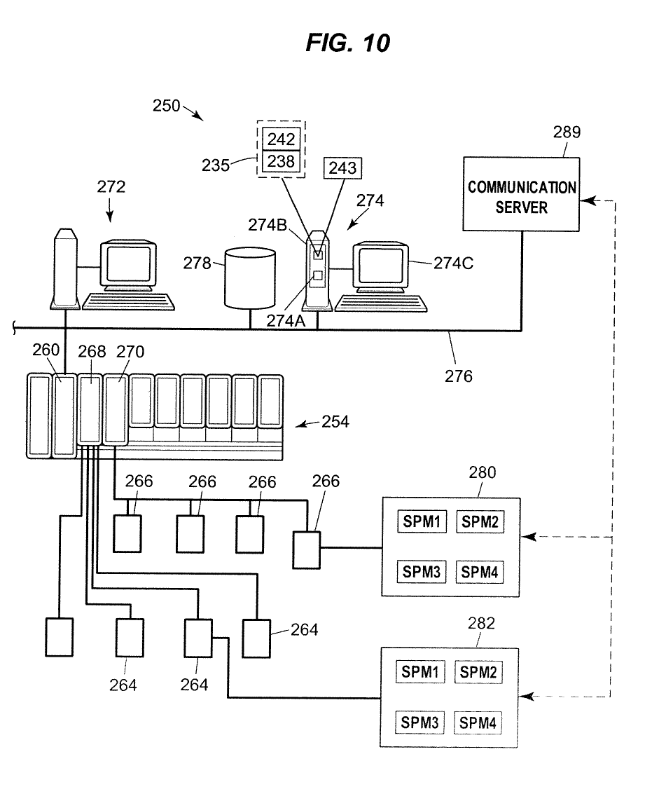

The fluid catalytic cracking unit of FIG. 1 may operate in a process plant as one part or piece of equipment of many sets of interconnected equipment, thereby forming a process line. Generally, this equipment may be controlled and managed using a process control system such as that illustrated in FIGS. 9 and 10.

Referring specifically to FIG. 9, an example process plant 210 in which an abnormal situation prevention system may be implemented includes a number of control and maintenance systems interconnected together with supporting equipment via one or more communication networks. In particular, the process plant 210 of FIG. 9 includes one or more process control systems 212 and 214. The process control system 212 may be a traditional process control system such as a PROVOX or an RS3 system or any other control system which includes an operator interface 212A coupled to a controller 212B and to input/output (I/O) cards 212C which, in turn, are coupled to various field devices such as analog and Highway Addressable Remote Transmitter (HART) field devices 215. The process control system 214, which may be a distributed process control system, includes one or more operator interfaces 214A coupled to one or more distributed controllers 214B via a bus, such as an Ethernet bus. The controllers 214B may be, for example, DeltaV™ controllers sold by Emerson Process Management of Austin, Tex. or any other desired type of controllers. The controllers 214B are connected via I/O devices to one or more field devices 216, such as for example, HART or FOUNDATION® Fieldbus field devices or any other smart or non-smart field devices including, for example, those that use any of the PROFIBUS®, WORLDFIP®, Device-Net®, AS-Interface and CAN protocols. Generally, a process controller may communicate with a plant network system to provide information about operations under the process controller's management (e.g., field device operation) and to receive setpoint signals from the plant network system that are used in adjusting the operation of a process controller. As is known, the field devices 216 may control a physical process parameter (e.g., as an actuator) or may measure a physical process parameter (e.g., as a sensor). The field devices may communicate with the controllers 214B to receive a process control signal or to provide data on a physical process parameter. The communication may be made via analog or digital signals. I/O devices may receive messages from a field device for communication to a process controller or may receive messages from a process controller for a field device. The operator interfaces 214A may store and execute tools 217, 219 available to the process control operator for controlling the operation of the process including, for example, control optimizers, diagnostic experts, neural networks, tuners, etc.

Still further, maintenance systems may be connected to the process control systems 212 and 214 or to the individual devices therein to perform maintenance and monitoring activities. For example, a maintenance computer 218 may be connected to the controller 212B and/or to the devices 215 via any desired communication lines or networks (including wireless or handheld device networks) to communicate with and, in some instances, reconfigure or perform other maintenance activities on the devices 215. Similarly, maintenance applications may be installed in and executed by one or more of the user interfaces 214A associated with the distributed process control system 214 to perform maintenance and monitoring functions, including data collection related to the operating status of the devices 216.

As illustrated in FIG. 9, a computer system 274 may implement at least a portion of an abnormal situation prevention system 235, and in particular, the computer system 274 may store and implement a configuration application 238 and an abnormal operation detection system 242. Additionally, the computer system 274 may implement an alert/alarm application 243.

FIG. 10 illustrates a portion 250 of the example process plant 210 of FIG. 9, including computer system 274, for the purpose of describing one manner in which the abnormal situation prevention system 235 and/or the alert/alarm application 243 may communicate with various devices in the portion 250 of the example process plant 210.

Generally speaking, the abnormal situation prevention system 235 may communicate with abnormal operation detection systems optionally located in the field devices 215, 216, the controllers 212B, 214B, (shown in FIG. 9) and any other desired devices and equipment within the process plant 210, and/or the abnormal operation detection system 242 in the computer system 274, to configure each of these abnormal operation detection systems and to receive information regarding the operation of the devices or subsystems that they are monitoring. The abnormal situation prevention system 235 may be communicatively connected via a hardwired bus 245 to each of at least some of the computers or devices within the plant 210 or, alternatively, may be connected via any other desired communication connection including, for example, wireless connections, dedicated connections which use OPC, intermittent connections, such as ones which rely on handheld devices to collect data, etc. Likewise, the abnormal situation prevention system 235 may obtain data pertaining to the field devices and equipment within the process plant 210 via a LAN or a public connection, such as the Internet, a telephone connection, etc. (illustrated in FIG. 9 as an Internet connection 246) with such data being collected by, for example, a third party service provider. Further, the abnormal situation prevention system 235 may be communicatively coupled to computers/devices in the plant 210 via a variety of techniques and/or protocols including, for example, Ethernet, Modbus, HTML, XML, proprietary techniques/protocols, etc.

The portion 250 of the process plant 210 illustrated in FIG. 10 includes a distributed process control system 254 having one or more process controllers 260 connected to one or more field devices 264 and 266 via input/output (I/O) cards or devices 268 and 270, which may be any desired types of I/O devices conforming to any desired communication or controller protocol. The field devices 264 are illustrated as HART field devices and the field devices 266 are illustrated as FOUNDATIONS Fieldbus field devices, although these field devices may operate using any other desired communication protocols. Additionally, each of the field devices 264 and 266 may be any type of device such as, for example, a sensor, a valve, a transmitter, a positioner, etc., and may conform to any desired open, proprietary or other communication or programming protocol, it being understood that the I/O devices 268 and 270 must be compatible with the desired protocol used by the field devices 264 and 266.

In any event, one or more user interfaces or computers 272 and 274 (which may be any types of personal computers, workstations, etc.) accessible by plant personnel such as configuration engineers, process control operators, maintenance personnel, plant managers, supervisors, etc. may coupled to the process controllers 260 via a communication line or bus 276 which may be implemented using any desired hardwired or wireless communication structure, and using any desired or suitable communication protocol such as, for example, an Ethernet protocol. In addition, a database 278 may be connected to the communication bus 276 to operate as a data historian that collects and stores configuration information as well as on-line process variable data, parameter data, status data, and other data associated with the process controllers 260 and the field devices 264 and 266 within the process plant 250. Thus, the database 278 may operate as a configuration database to store the current configuration, including process configuration modules, as well as control configuration information for the process control system 254 as downloaded to and stored within the process controllers 260 and the field devices 264 and 266. Likewise, the database 278 may store historical abnormal situation prevention data, including statistical data (e.g., training data) collected by the field devices 264 and 266 within the process plant 210, statistical data determined from process variables collected by the field devices 264 and 266, and other types of data.

While the process controllers 260, I/O devices 268 and 270, and field devices 264 and 266 are typically located down within and distributed throughout the sometimes harsh plant environment, the workstations 272 and 274, and the database 278 are usually located in control rooms, maintenance rooms or other less harsh environments easily accessible by operators, maintenance personnel, etc.

Generally speaking, the process controllers 260 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 250. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 210. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 10, the maintenance workstation 274 includes a processor 274A, a memory 274B and a display device 274C. The memory 274B may store the abnormal situation prevention application 235 and the alert/alarm application 243 discussed with respect to FIG. 1 in a manner that these applications may be implemented on the processor 274A to provide information to a user via the display 274C (or any other display device, such as a printer).

Each of one or more of the field devices 264 and 266 may include a memory (not shown) for storing routines such as routines for implementing statistical data collection pertaining to one or more process variables sensed by sensing devices and/or routines for abnormal operation detection. Each of one or more of the field devices 264 and 266 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As illustrated in FIG. 10, some (and potentially all) of the field devices 264 and 266 may include abnormal operation detection modules 280 and 282. While the blocks 280 and 282 of FIG. 10 are illustrated as being located in one of the devices 264 and in one of the devices 266, these or similar modules may be located in any number of the field devices 264 and 266, may be located in other devices, such as the controller 260, the I/O devices 268, 270 or any of the devices illustrated in FIG. 10. Additionally, the modules or blocks 280 and 282 may be in any subset of the devices 264 and 266.

Generally speaking, the blocks 280 and 282 or sub-elements of these blocks, collect data, such a process variable data, from the device in which they are located and/or from other devices. Additionally, the blocks 280 and 282 or sub-elements of these blocks may process the variable data and perform an analysis on the data for any number of reasons. In other words, the blocks 280 and 282 may represent AOD module 70 or 90 as described above. Consequently, the blocks 280 or 282 may include a set of one or more statistical process monitoring (SPM) blocks or units such as blocks SPM1-SPM4.

It is to be understood that while the blocks 280 and 282 are shown to include SPM blocks in FIG. 10, the SPM blocks may instead be stand-alone blocks separate from the blocks 280 and 282, and may be located in the same device as the corresponding block 280 or 282 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 250 may be performed or implemented at least partially as described in U.S. Pat. No. 6,017,143, which is hereby incorporated by reference.

It is to be understood that although the blocks 280 and 282 are shown to include SPM blocks in FIG. 10, SPM capability is not required of the blocks 280 and 282. For example, abnormal operation detection routines of the blocks 280 and 282 may operate using process variable data not processed by an SPM block. As another example, the blocks 280 and 282 may each receive and operate on data provided by one or more SPM blocks located in other devices. As yet another example, the process variable data may be processed in a manner that is not provided by many typical SPM blocks. As just one example, the process variable data may be filtered by a finite impulse response (FIR) or infinite impulse response (IIR) filter such as a bandpass filter or some other type of filter. As another example, the process variable data may be trimmed so that it remained in a particular range. Of course, known SPM blocks may be modified to provide such different or additional processing capabilities.

The block 282 of FIG. 10, which is illustrated as being associated with a transmitter, may have a plugged line detection unit that analyzes the process variable data collected by the transmitter to determine if a line within the plant is plugged. In addition, the block 282 may include one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 280 and 282 are illustrated as including four SPM blocks each, the blocks 280 and 282 may have any other number of SPM blocks therein for collecting and determining statistical data.

Implementing the AOD Modules

The AOD modules 70, 90, and 140 of FIGS. 3, 4 and 8, respectively, may be implemented in the process control system illustrated in FIGS. 9 and 10. For example, the AOD modules 70, 90, and 140 may be implemented wholly or partially in one or more field devices coupled to the reactor cyclone 20, the element 45, the steam generator 46, or the fractionator 40. For example, if the AOD module 90 is used, then the SPM blocks 92 and 94 of AOD module 90 may be implemented in the field device 206 while the model block 96 and/or the deviation detector 98 may be implemented in a process controller 260, or a workstation 274 (e.g., via detection application 242) or some other device. Similarly, the process blocks of AOD module 70 may be wholly implemented in a field device (e.g., field devices 264 or 266) or divided among a field device and a process controller or other device. In one particular implementation, the AOD system 70, 90, or 140 may be implemented as a function block, such as a function block described above and used in a process control system that implements a Fieldbus protocol. Such a function block may or may not include the SPM blocks 92 and 94. In another implementation, at least one of the blocks of AOD 70, 90, or 140 may be implemented as a function block.

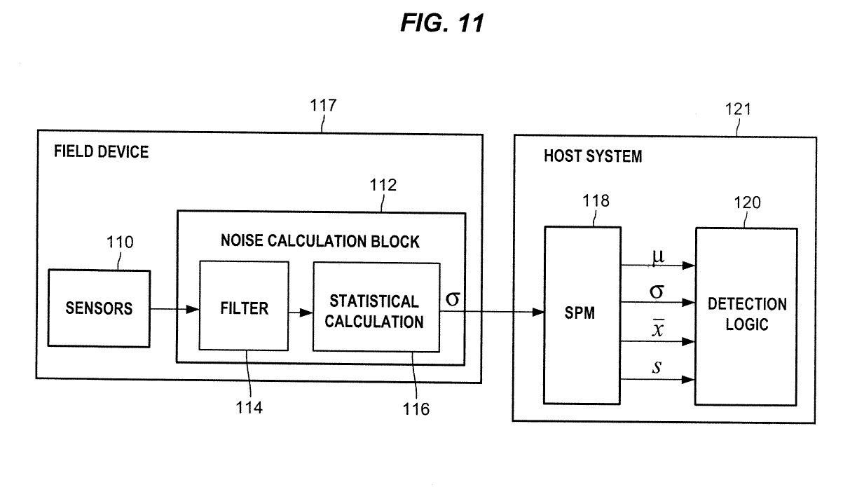

FIG. 11 illustrates an embodiment where the sensors 110 and noise calculation block 112 (containing a filter 114 and calculation block 116) for determining the noise across the element 45 is implemented in a field device 117. In this embodiment, the field device calculates the noise and provides data on the noise to a host system 121. The host system may be a workstation, such as workstation 274 in FIGS. 9 and 10. The host system 121 may then implement the SPM block 118 and detection block 120. The host system 121 may receive an indication of an abnormal event from the detection block 120 and manage an appropriate alert based on the indication.

In one embodiment, the host system or workstation 121 may process the data from the field device 117 based on a user-desired length of a sampling window and the length of a sampling window available from the AOD block in the field device 117. In choosing the length of the sampling window, there may be a trade-off between the consistency of statistical calculations, and the length of time it takes to detect an abnormal situation. In some implementations, it may be desirable to have the length of the sampling window longer than the field device 117 is able to calculate (for example, an overall sampling window of length 10 minutes may be used, where the AOD block in, a field device may only store 1 minute of data). In this case, the filtered standard deviation may be calculated in the field device over a relatively short sampling window (e.g., 5 seconds). The SPM block 118, implemented in the host system 121, may learn the initial (normal) parameters (baseline mean and baseline standard deviation) with respect to this AOD Data. The variance in the filtered standard deviation may then be used to set a threshold, and the solids buildup may be detected when this threshold is exceeded.

While the AOD functionality may be implemented in devices other than a field device, there may advantages to using a field device with built-in signal processing (e.g., a Rosemount 3051S with abnormal situation prevention). In particular, because a process control field device has access to data sampled at a much faster rate than a host system (e.g., a workstation collecting measurements from field devices via a process controller), statistical signatures calculated in the field device may be more accurate. As a result, AOD and SPM modules implemented in a field device are generally capable of determining better statistical calculations with respect to the collected process variable data than a block located outside of the device in which the process variable data is collected.

It should be noted that a Rosemount 3051 FOUNDATION Fieldbus transmitter has an Advanced Diagnostics Block (ADB) with SPM capabilities. This SPM block may have the capability to learn a baseline mean and standard deviation of a process variable, compare the learned process variables against a current mean and standard deviation, and trigger a PlantWeb alert if either of these changes by more than the user-specified threshold. It is possible that the SPM functionality in the field device may be configured to operate as an AOD module based on the description herein to detect abnormal solids buildup in a main column bottom, provided that the measured process parameter does not change as a result of the process moving into other normal operating regions.

The alert/alarm application 243 may be used to manage and/or route alerts created by the AOD modules 280 and 282, which may include AOD modules 70, 90, and/or 140. In this case, when abnormal solids buildup is detected via any of the measured process parameters, a meaningful alert may be provided to a person or group responsible for monitoring and maintaining operations (e.g., an operator, an engineer, a maintenance personnel, etc.). When coking/solids buildup occurs and has been detected by any of above described methodologies, an alert may be sent to a user. Guided help may then be provided to help a user resolve the abnormal buildup situation through a user interface (e.g., on workstation 272 or 274 connected to the process control system). Corrective actions that may be presented to a user in response to the alert may include directions to: clean steam generator tubes (e.g., hydro-blast the tubes); run sandblasting chemicals in pipes; adjust a quench to the column bottom; lower fluid catalytic cracking reactor riser top temperature to decrease coking; and/or make other adjustments to fluid catalytic cracking operation (for example, decrease unit rate).

The AOD modules 70, 90, or 140 may provide information to the abnormal situation prevention system 235 via the alert application 243 and/or other systems in the process plant. For example, the deviation indicator generated by the deviation detector 98 or a calculation block 76 may be provided to the abnormal situation prevention system 235 and/or the alert/alarm application 243 to notify an operator of the abnormal condition. As another example, after the model implementation block 96 of AOD Module 90 has been trained, parameters of the model may be provided to the abnormal situation prevention system 235 and/or other systems in the process plant so that an operator can examine the model and/or so that the model parameters can be stored in a database. As yet another example, the AOD modules 70 or 90 may provide X, Y, and/or Y_{P} values to the abnormal situation prevention system 235 so that an operator may view the values (e.g., when a deviation has been detected).

In a process control system, the AOD module 70 or 90 (implemented via a field device or process controller) may be in communication with configuration application 238 to permit a user to configure the AOD modules 70 or 90. For instance, one or more of the blocks of module 70 or 90 may have user configurable parameters that may be modified via the configuration application 238.

Although the following text sets forth a detailed description of numerous different embodiments, it should be understood that the legal scope of the description is defined by the words of the claims set forth at the end of this patent. The detailed description is to be construed as exemplary only and does not describe every possible embodiment because describing every possible embodiment would be impractical, if not impossible. Numerous alternative embodiments may be implemented, using either current technology or technology developed after the filing date of this patent, which would still fall within the scope of the claims.

1. A method for detecting solids buildup in a main fractionator bottom of a fluid catalytic cracking system comprising:
monitoring, over a first period of time, a value of at least one process parameter of a set of process parameters of a fluid catalytic cracking system, the set of process parameters including
i) a differential pressure across a cyclone of a fluid catalytic cracking unit providing effluents to a main fractionator,
ii) a differential pressure across an element downstream from an outlet of the main fractionator bottom,
iii) a heat transfer parameter at a steam generator of the main fractionator, and
iv) a differential pressure across the main fractionator;
monitoring over a second period of time the value of the at least one process parameter;
determining an abnormal solids buildup in the main fractionator bottom based on a statistical value calculated from the monitored values of the first period and on the monitored values of the second period.

2. The method of claim 1, further comprising determining a mean of the at least one monitored process parameter during the first period and determining an abnormal solids buildup condition if a mean value of the at least one monitored process parameter over the second period exceeds the mean of the at least one monitored process parameter by more than a threshold.

3. The method of claim 2, further comprising setting the threshold based on one of a standard deviation of the at least one process parameter measured over the first period or a percentage of the mean of the at least one process parameter measured over the first period.

4. The method of claim 1, further comprising measuring an inlet temperature (Tᵢₙ) and an outlet temperature (Tₒᵤₜ) of a steam generator of an energy recovery loop of the fluid catalytic cracking system;
calculating a temperature difference (ΔT) of the inlet and outlet temperature as ΔT=Tᵢₙ−Tₒᵤₜ;
measuring the flow rate through the steam generator (ω);
determining a specific heat (cₚ); and
calculating the heat transfer parameter (Q ) according to the equation Q=ω·cₚ·ΔT.

5. The method of claim 4, further comprising using one of a mass flow rate or a volumetric flow rate as the flow rate through the steam generator (ω).

6. The method of claim 1, further comprising filtering values of the monitored differential pressure across the element using a high pass filter and calculating the standard deviation of the high pass filtered differential pressure values.

7. The method of claim 6, further comprising calculating a mean of the standard deviation of the high pass filtered differential pressure values during the first period and determining an abnormal solids buildup in the main fractionator bottom if a mean of the standard deviation of the high pass filtered differential pressure values over the second period exceeds the mean of the standard deviation over the first period by more than a threshold.

8. The method of claim 6, further comprising calculating a mean of the variance of the high pass filtered differential pressure values during the first period and determining an abnormal solids buildup in the main fractionator bottom if a mean of the variance of the high pass filtered differential pressure values over the second period exceeds the mean of the variance over the first period by a threshold.

9. The method of claim 1, further comprising
monitoring a second set of process parameters that affect the at least one process parameter of the first set of process parameters of the fluid catalytic cracking system;
generating a regression model for the first period of time based on values of the at least one monitored process parameter over the first period and the second set of process parameters affecting the at least one process parameter of the fluid catalytic cracking system;
calculating a predicted value of the at least one process parameter using the regression model; and
determining an abnormal solids buildup in the main fractionator bottom if a difference between a value of the monitored at least one process parameter over the second period and the predicted value of the at least one process parameter is greater than a threshold.

10. The method of claim 9, further comprising generating a first regression model for a first range of values of the second set of process parameters affecting the at least one process parameter of the fluid catalytic cracking system and a second regression model for a second range of values of the second set of process parameters affecting the at least one process parameter of the fluid catalytic cracking system.

11. The method of claim 1, wherein the at least one process parameter of a set of process parameters of the fluid catalytic cracking system is a differential pressure across a cyclone of a fluid catalytic cracking unit providing effluents to a main fractionator.

12. The method of claim 1, wherein the at least one process parameter of a set of process parameters of the fluid catalytic cracking system is a differential pressure across an element downstream from an outlet of the main fractionator bottom.

13. The method of claim 1, wherein the at least one process parameter of a set of process parameters of the fluid catalytic cracking system is a heat transfer parameter at a steam generator of the main fractionator.

14. The method of claim 1, wherein the at least one process parameter of a set of process parameters of the fluid catalytic cracking system is a differential pressure across the main fractionator.

15. A device for detecting abnormal solids buildup in a main fractionator bottom comprising:
a set of sensors for measuring a value of at least one process parameter of a set of process parameters of a fluid catalytic cracking system, the set including
i) a differential pressure across a cyclone of a fluid catalytic cracking unit providing effluents to a main fractionator,
ii) a differential pressure across an element downstream from an outlet of the main fractionator bottom,
iii) a heat transfer at a steam generator of an energy recovery loop of the main fractionator bottom, or
iv) a differential pressure across the main fractionator;
a statistical process monitoring module that receives data on the measured at least one process parameter and that determines a first set of statistical parameters of the measured pressure differential over a first period, the statistical parameters including a mean and a standard deviation;
a detection module that determines an abnormal solids buildup condition based on the first set of statistical parameters and a measured value of the at least one process parameter over a second period, the detection module generating an alert when an abnormal solids buildup condition exists.

16. The device of claim 15, wherein the statistical process monitoring module determines an initial mean of the at least one monitored process parameter during the first period and wherein the detection module determines an abnormal solids buildup condition if a mean of the at least one measured process parameter over the second period exceeds the initial mean by more than a threshold.

17. The device of claim 15, wherein the set of sensors measures an inlet temperature Tᵢₙ, and an outlet temperature Tₒᵤₜ of the steam generator and measures a flow rate through the steam generator (ω), and wherein the device of claim 15 further comprises a processor that calculates a temperature difference ΔT of the inlet temperature Tᵢₙ and outlet temperature Tₒᵤₜ as ΔT=Tᵢₙ−Tₒᵤₜ, that determines a specific heat (cₚ), and that calculates the heat transfer according to the equation Q=ω·cₚ·αT.

18. The device of claim 15, further comprising a filter module that filters values of the monitored differential pressure across the element using a high pass filter and wherein the statistical process monitoring module calculates the standard deviation of the high pass filtered differential pressure values.

19. The device of claim 18, further comprising a second statistical process monitoring module that calculates a mean of the standard deviation of the high pass filtered differential pressure values during the first period and wherein the detection module determines an abnormal solids buildup in the main fractionator bottom if a mean of the standard deviation of the high pass filtered differential pressure values over the second period exceeds the mean of the standard deviation over the first period by more than a threshold.

20. The device of claim 15, further comprising a prediction module that implements a regression model to calculate a predicted value of the at least one process parameter, wherein the regression model is generated during the first period based on the measured value of the at least one process parameter and a set of monitored process parameters affecting the at least one process parameter;
and wherein the detection module determines an abnormal solids buildup in the main fractionator bottom if a difference between the measured value of the at least one process parameter over the second period and the predicted value of the at least one process parameter is greater than a threshold.

21. A device for detecting abnormal solids buildup in a main fractionator bottom comprising:
a set of sensors for measuring a value of at least one process parameter of a first set of process parameters of a fluid catalytic cracking system, the set including
i) a differential pressure across a cyclone of a fluid catalytic cracking unit providing effluents to a main fractionator,
ii) a differential pressure across an element downstream from an outlet of the main fractionator bottom,
iii) a heat transfer at a steam generator of the main fractionator, or
iv) a differential pressure across the main fractionator;
a regression implementation module that receives data on a second set of parameters affecting the at least one process parameter of the first set of process parameters, the regression implementation module outputting a predicted value of the at least one process parameter of the first set of process parameters;
a detection module that determines an abnormal solids buildup condition if the difference between the predicted value of the at least one process parameter of the first set of process parameters and an actual value of the at least one process parameter of the first set of process parameters is more than a threshold.

22. The device of claim 21, wherein the regression implementation module calculates a regression model during a first period based on values of the at least one process parameter of the first set of process parameters and the second set of process parameters affecting the at least one process parameter of the first set of process parameters and wherein the regression implementation module implements the regression model during a second period to predict the value of the at least one process parameter of the first set of process parameters.

23. A system for detecting solids buildup in a main fractionator bottom of a fluid catalytic cracking system comprising:
a process control system including a workstation, a process controller, and a plurality of field devices, wherein the workstation, process controller, and the plurality of field devices are communicatively connected to each other;
a fluid catalytic cracking system having a reactor cyclone, a main fractionator, and an energy recovery loop coupled to the bottom of the main fractionator, wherein at least one of the plurality of field devices is adapted to measure the value of at least one process parameter of a set of process parameters of the fluid catalytic cracking system, the set including a) a differential pressure across a cyclone of a fluid catalytic cracking unit providing effluents to a main fractionator, b) a standard deviation of a differential pressure across an element downstream from a bottom outlet of the main fractionator, c) a heat transfer at a steam generator of the main fractionator, and d) a differential pressure across the main fractionator;
an abnormal operation detection device adapted to receive data on the at least one process parameter over a first period of time and over a second period of time, and to generate an alert when a set of measured process parameter values of the first period and a set of measured process parameter values of the second period differ by more than a threshold.

24. The system of claim 23, comprising implementing the abnormal operation detection device as part of one of the field device or the workstation.

25. The system of claim 23, further comprising an alarm management device that is adapted to receive the alert from the abnormal operation device and to display an indication of solids buildup in the main fractionator bottom.
